(19) United States
(12) Patent Application Publication
(10) Pub. No.: US 2009/0320596 A1
(43) Pub. Date: Dec. 31, 2009

(54) ACCELERATION SENSOR WITH COMB-SHAPED ELECTRODES

(76) Inventors: Johannes Classen, Reutlingen (DE); Markus Heitz, Kusterdingen (DE); Found Bennini, Reutlingen (DE)

Correspondence Address: KENYON & KENYON LLP, ONE BROADWAY, NEW YORK, NY, 10004, US

(21) Appl. No.: 12/304,604

(22) PCT Filed: Oct. 19, 2007
(86) PCT No.: PCT/EP2007/061189

§ 371 Date: Apr. 2, 2009

(30) Foreign Application Priority Data
Dec. 19, 2006 (DE) 102006059928.4

(51) Int. Cl. G01P 15/125

(52) U.S. Cl. 73/514.32

(57) ABSTRACT

A micromechanical capacitive acceleration sensor having at least one seismic mass that is connected to a substrate so as to be capable of deflection, at least one electrode connected fixedly to the substrate, and at least one electrode connected to the seismic mass, the at least one electrode connected fixedly to the substrate and the at least one electrode connected to the seismic mass being realized as comb-shaped electrodes having lamellae that run parallel to the direction of deflection of the seismic mass, the lamellae of the two comb-shaped electrodes overlapping partially in the resting state.

### FIELD OF THE INVENTION

The present invention relates to a capacitive micromechanical acceleration sensor having comb-shaped electrodes, distinguished by particularly low zero-point errors.

### BACKGROUND INFORMATION

In the manufacture of micromechanical acceleration sensors, movable structures are created on a substrate by a succession of deposition and structuring steps, said structures representing mechanical spring-mass systems in which, when accelerations occur, at least one seismic mass is deflected relative to the substrate, against a known reset force. The principle of capacitive sensors is based on the fact that both electrodes connected to the seismic mass and also electrodes connected to the substrate are present that are wired together to form capacitors and that, when there is a deflection of the seismic mass, execute a movement relative to each other that corresponds to the deflection of the seismic mass, the capacitance of the capacitors formed by the electrodes changing as a function that is as clear as possible of the deflection of the seismic mass. This change in the capacitance is acquired by circuitry and evaluated, and makes it possible to calculate acceleration that has occurred. The electrodes may be plate capacitors; here sensor geometries have proven effective that are based either on the evaluation of a change of distance between the electrodes or a change of the size of the areas of overlap. In the case of an acceleration-dependent change in distance dx, the change in capacitance resulting from an acceleration is given by dC/C≈dx/x₀, where C is the overall capacitance, i.e. the rest capacitance plus parasitic capacitances of the system, and x₀ is the resting distance between the electrodes. In cases in which the size of the areas of overlap changes only as a function of an overlap length, the change in capacitance resulting from an acceleration or deflection dx of the seismic mass is given by dC/C≈dx/l₀, where C is again the overall capacitance and l₀ is the length of overlap of the electrodes in the resting state.

As a result of manufacturing processes or subsequent loads, in particular thermal loads, substrate deformations can occur that are connected with corresponding relative movements between individual structured elements connected to the substrate. Particularly critical here are zero-point deflections dx₀ of the electrodes that are connected directly to the substrate, opposite the electrodes connected to the seismic mass; said deflections cause undesired offset signals that behave proportionally to dx₀/x₀ or dx₀/l₀.

It is understood to reduce this problem through the use of closely adjacent fastening areas in which the connection between the individual structured elements, movable relative to one another, and the substrate is realized (DE 196 39 946 A1). However, this solution requires relatively long connecting beams between the fastening areas and the fastened structured elements, creating a large space requirement and a disadvantageously reduced rigidity of the system. In addition, this solution relates only to an acceleration sensor in which the movement of the electrodes takes place perpendicular to one another, so that zero-point errors occur proportional to dx₀/x₀. Because, in order to achieve a sufficient sensitivity in such sensors, the rest distance x₀ between the electrodes is often selected very small, relatively small zero-point deflections dx₀ result in significant or intolerable offset signals that cannot be overcome under realistic operating conditions, even by the known reduction of the distances between the fastening areas on the substrate.

### SUMMARY OF THE INVENTION

### Technical Object

The object of the present invention is to indicate a sensor structure for a micromechanical acceleration sensor that is distinguished by low zero-point errors, while avoiding the disadvantages of the prior art. In particular, the dependence of the zero-point signals on occurring substrate deformations is to be reduced.

### Technical Solution

This object is achieved by a micromechanical acceleration sensor having the features described herein. Further advantageous constructions of an acceleration sensor according to the present invention are also described herein.

The core of the present invention consists in a constructive realization of movable electrodes connected to a seismic mass, and of fixed electrodes connected to a substrate, as comb-shaped electrodes arranged in pairs. The comb-shaped electrodes each have transverse webs on which there are situated electrode lamellae. The situation of the comb-shaped electrodes takes place in such a way that the lamellae of the comb-shaped electrodes run parallel to the direction of deflection of the seismic mass, and the open areas of the lamellae systems point towards one another, such that the lamellae of two comb-shaped electrodes situated in a pair may overlap at least partly. In the area of the overlap of the lamellae, the comb-shaped electrodes form capacitors whose capacitance varies when the size of the areas of overlap changes.

The present invention is embodied by a micromechanical capacitive acceleration sensor having at least one seismic mass that is connected to a substrate so as to be capable of deflection, at least one electrode connected fixedly to the substrate, and at least one electrode connected to the seismic mass, the at least one electrode connected fixedly to the substrate and the at least one electrode connected to the seismic mass being realized as comb-shaped electrodes having lamellae that run parallel to the direction of deflection of the seismic mass, the lamellae of the two comb-shaped electrodes overlapping partially in the rest state.

### ADVANTAGEOUS EFFECTS

The use according to the present invention of comb-shaped electrodes in which a parallel movement of lamellae running in parallel results in a change of a length of overlap that is evaluated as a measure of the deflection of the seismic mass results in various advantages. In this case, the zero-point error is given by dx₀/l₀. Because overlap length l₀ can be selected significantly larger than resting distance x₀ in a distance-based capacitor system, a significant reduction occurs in offset signal dC/C relative to conventional sensor systems, given an otherwise comparable zero-point deflection dx₀.

The advantages of a system in which all fastening areas are situated in a central area of the substrate can also be exploited in sensor systems according to the present invention, enabling a particularly low sensitivity to substrate bendings and similar deformations to be achieved.

In particular, if a seismic mass is realized as a frame that surrounds the electrode system, it is possible through corresponding structuring measures to accommodate all relevant connecting areas closely adjacent to one another in the center of the substrate. It will be possible to use the sensor configuration according to the present invention advantageously, in particular, in what are known as x- and y-acceleration sensors, in which a detection of accelerations takes place in the wafer plane. It is particularly advantageous if all fastening areas in which functional assemblies are fastened to the substrate are situated immediately adjacent to one another in such a way that they are situated on a line that runs transverse to the direction of deflection of the seismic mass. Changes in distance between the individual fastening areas lead in this case almost exclusively to relative movements between the functional assemblies that occur transverse to the measurement deflection of the seismic mass and thus have no influence on the overlap length. In contrast, a cross-displacement of comb-shaped electrodes that are meshed with one another has no influence on the capacitance of a capacitor formed by a pair of comb-shaped electrodes, because increases and reductions in the distance between the lamellae of the comb-shaped electrodes cancel each other out.

Through the use of comb-shaped electrodes, it is advantageously possible to realize large overlap areas in a small space, resulting in correspondingly large capacitance values and a concomitant high sensitivity of acceleration sensors designed in this way. This holds in particular if a plurality of comb-shaped electrodes connected fixedly to the substrate and a plurality of comb-shaped electrodes connected to the seismic mass respectively form pairs of comb-shaped electrodes whose overlap length is a function of the deflection of the seismic mass. In addition, for the use of differential capacitive evaluation methods it is advantageous if at least one comb-shaped electrode pair is present whose overlap length increases when there is a deflection of the seismic mass in the wafer plane, and at least one additional pair of comb-shaped electrodes is present whose overlap length decreases given the same deflection of the seismic mass in the wafer plane. The same holds correspondingly for a system of a plurality of pairs of comb-shaped electrodes.

The realization of the seismic mass as a frame surrounding the electrode system creates the possibility of using additional advantageous constructive means. The fastening of the seismic mass to the substrate can advantageously take place via a connecting beam that is fastened in a central area of the substrate and is connected at its ends to springs for the deflectable mounting of the seismic mass. These springs are advantageously realized as S-shaped flexible springs. A particularly low cross-sensitivity of the seismic mass results if the suspension is realized via a pair of S-shaped flexible springs that are fashioned mirror-symmetrically.

In accordance with the principle of a closely adjacent situation of required fastening areas, it is additionally advantageous if, on both sides of the connecting beam, bearer beams run in order to accommodate the comb-shaped electrodes that are connected fixedly to the substrate, said bearer beams also being fastened to the substrate only in a central area of the substrate. For process-technical reasons, it is advantageous if at least parts of the seismic mass and/or of the cross-webs of the comb-shaped electrodes are realized as perforated surfaces.

The present invention is explained in more detail with reference to an exemplary embodiment.

### BRIEF DESCRIPTION OF THE DRAWINGS

FIG. 1 shows a representation of a sensor system according to the present invention in a top view of the plane of the seismic mass.

FIG. 2 shows a sectional view through a sensor system according to the present invention, along the line I-I of FIG. 1.

### DETAILED DESCRIPTION

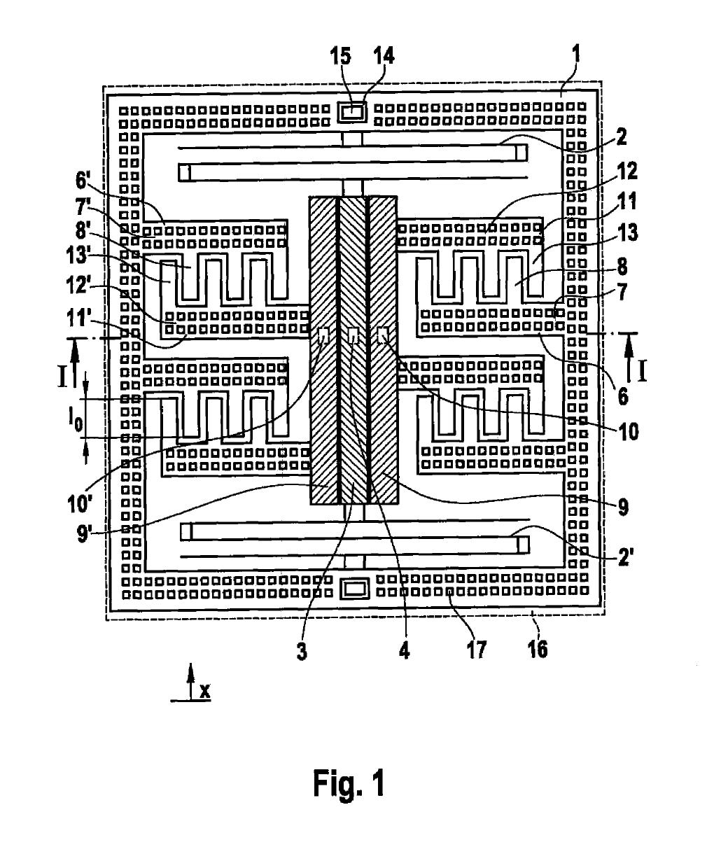

FIG. 1 shows a representation of a sensor system according to the present invention for detecting accelerations in the low-g range in a direction parallel to the wafer plane, in a top view of the plane of the seismic mass. Seismic mass 1 is fashioned as a rectangular frame that is connected, via a pair of S-shaped flexible springs 2, 2′, to a connecting beam 3, which in turn has a central fastening area 4 in which the connecting beam is structurally connected to a substrate 5. S-shaped flexible springs 2, 2′ are situated in mirror-symmetrical fashion, thus defining the direction of deflection of seismic mass 1 in the x direction, because S-shaped flexible springs 2, 2′ mutually prevent deformations of each other in the case of transverse accelerations. In this way, a low cross-sensitivity results without having to increase the spring rigidity in the x direction. This is a precondition of the suitability of the sensor according to the present invention for use in measuring small accelerations. Alternative spring arrangements, for example multiple U-springs having low overall rigidity, can also be realized, but require more space.

Fixedly connected to frame-shaped seismic mass 1 are comb-shaped electrodes 6, 6′, each having a transverse web 7, 7′, each of which bears a plurality of lamellae 8, 8′ that run at a right angle to transverse web 7, 7′. Lamellae 8, 8′ run parallel to the direction of deflection of seismic mass 1. Comb-shaped electrodes 6, 6′, which are connected fixedly to frame-shaped seismic mass 1, lead from the frame area, which runs parallel to the direction of deflection of seismic mass 1, into the interior of the frame. In this way, frame-shaped seismic mass 1 simultaneously forms the outer boundary of the deflectable functional element, which is formed from seismic mass 1 and from comb-shaped electrodes 6, 6′ that are fastened to said mass and that are themselves made up of transverse webs 7, 7′ and lamellae 8, 8′. Parallel to connecting beam 3 run bearer beams 9, 9′, each of which also has a central fastening area 10, 10′ in which bearer beams 9, 9′ are structurally connected to substrate 5. Bearer beams 5, 5′ each have, on the side facing away from connecting beam 3, comb-shaped electrodes 11, 11′ that are likewise each made up of a transverse web 12, 12′ and lamellae 13, 13′. Through their connection to bearer beams 9, 9′, which are themselves connected fixedly to the substrate, these comb-shaped electrodes 11, 11, represent electrodes connected fixedly to substrate 5 in the sense of the present invention.

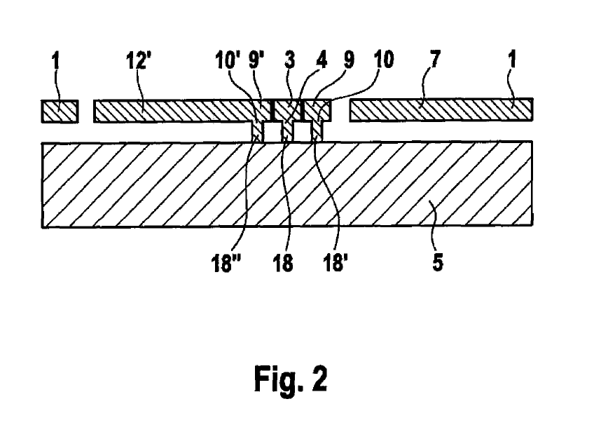

In the sense of the present invention, a “fixed connection” is to be understood as meaning that deformations or deflections of the fastened structures upon the occurrence of a measurement and/or disturbing acceleration are small relative to the deflection of seismic mass 1 that occurs in these cases. The cross-sections and dimensions shown in FIGS. 1 and 2 are not to scale, and are not intended to illustrate the static behavior of the depicted structures, but rather are intended only to describe their situation relative to one another.

Comb-shaped electrodes 11, 11′ on bearer beams 9, 9′, and comb-shaped electrodes 6, 6′ on frame-shaped seismic mass 1, are situated in such a way that their lamellae 8, 8′, 13, 13′ are oriented towards one another and overlap partially. In this way, pairs of comb-shaped electrodes are formed whose overlap length is a function of the deflection of seismic mass 1. The distance between the tips of the lamellae of a comb-shaped electrode and a transverse web, situated opposite these tips, of the respective other electrode of a pair of comb-shaped electrodes, is somewhat greater than the maximum deflection of seismic mass 1. The maximum deflection of seismic mass 1 is determined by stop structures that are formed by rectangular recesses 14 in frame-shaped seismic mass 1 and columns 15 that are fastened to substrate 5 and that protrude into these recesses. The area 16 of maximum deflection of seismic mass 1 is outlined in broken lines in the Figure. In the present exemplary embodiment, when this maximum deflection of seismic mass 1 occurs, contact of comb-shaped electrodes 6, 6′ 11, 11′, which form a capacitor, is avoided—by a small margin, but reliably. In this way, a maximum usable overlap of lamellae 8, 8′ 13, 13′ of comb-shaped electrodes 6, 6′ 11, 11′ results that is described by overlap length l₀ in the resting state of the sensor system. Because in this case overlap length l₀ is relatively large, when there is a typical error-based zero-point deflection dx₀ there results a significant reduction of offset signal dC/C in comparison with conventional sensor systems. Comb-shaped electrodes 6, 6′, 11, 11′ are situated in such a way that to the right of the arrangement of beams made up of connecting beams 3 and bearer beams 9, 9′ there are situated pairs 6, 11 of comb-shaped electrodes whose overlap lengths increase when there is a deflection of seismic mass 1 in the x direction, and to the left of the beam arrangement made up of connecting beams 3 and bearer beams 9, 9′ there are situated pairs 6′, 11′ of comb-shaped electrodes whose overlap lengths decreases when there is a deflection of seismic mass 1 in the x direction. In this way, the sensor system according to the present invention is particularly well-suited for differential capacitive evaluation methods, because a measurement signal that is to be generated is influenced very little by disturbing cross-accelerations and torsional accelerations in the wafer plane. For process-technical reasons, frame-shaped seismic mass 1, as well as transverse webs 7, 7′, 12, 12′ of comb-shaped electrodes 6, 6′, 11, 11′, have a perforation 17 in order to guarantee simple underetching during the exposure of the structures. Central fastening areas 4, 10, 10′ of connecting beam 3 and of bearer beams 9, 9′ are situated in a line that runs transverse to the direction of deflection of seismic mass 1.

The situation of all fastening areas 4, 10, 10′ in the central area of substrate 5 results in low sensitivity to substrate bendings and similar deformations. Due to the situation of all fastening areas 4, 10, 10′ on a line running transverse to the direction of deflection of the seismic mass, this low sensitivity to substrate bending is further improved in a targeted manner in the measurement direction (x direction) of the sensor system, because only deformations that cause a single fastening area to move out of alignment with the situation of all fastening areas 4, 10, 10′ will also cause a change in the measurement signal or the offset. However, such non-homogenous deformations often occur to a significantly lower extent, and under normal operating conditions are not relevant in terms of measurement in sensor systems according to the present invention.

FIG. 2 shows a schematic sectional representation through a sensor system according to the present invention, along the line I-I of FIG. 1. On a substrate 5 made of silicon, support structures, in the form of rectangular columns 18, 18′, 18″, are raised that lead to fastening areas 4, 10, 10′ of connecting beam 3 and of bearer beams 9, 9′, and that create the fixed connection thereof to substrate 5. Fastening areas 4, 10, 10′ are situated immediately adjacent to one another on sectional line I-I, transverse to the direction of deflection of seismic mass 1. Via substrate 5, the lateral extension of the system through frame-shaped seismic mass 1 is determined. In the left area of the drawing, the cross-section of seismic mass 1 in the area of a frame area that runs parallel to the direction of deflection is visible, and in the right area of the drawing the seismic mass is sectioned in the area of connection to a transverse web 7 of a comb-shaped electrode 6. Seismic mass 1 is connected to substrate 5 only by connecting beam 3. To the right of connecting beam 3, the cross-section of a bearer beam 9 is shown, and to the left of connecting beam 3 a bearer beam 9, is sectioned in the area of a transverse web 12′, connected to said bearer beam, of a comb-shaped electrode 11′.

1-10. (canceled)

11. A micromechanical capacitive acceleration sensor, comprising:
at least one seismic mass that is connected to a substrate, so as to be capable of deflection;
at least one electrode connected fixedly to the substrate; and
at least one electrode connected to the seismic mass, wherein the at least one electrode connected fixedly to the substrate and the at least one electrode connected to the seismic mass are fashioned as comb-shaped electrodes having lamellae that run parallel to the direction of deflection of the seismic mass, the lamellae of the two comb-shaped electrodes overlapping partially in the resting state.

12. The acceleration sensor of claim 11, wherein a plurality of comb-shaped electrodes connected fixedly to the substrate, and a plurality of comb-shaped electrodes connected to the seismic mass, are arranged to form pairs of comb-shaped electrodes whose overlap length is a function of the deflection of the seismic mass.

13. The acceleration sensor of claim 11, wherein the seismic mass is a frame that surrounds the electrode system.

14. The acceleration sensor of claim 11, wherein the seismic mass is connected to the substrate via S-shaped flexible springs.

15. The acceleration sensor of claim 11, wherein a connecting beam fastened in the central area of the substrate leads to springs that bear the seismic mass so that it is capable of being deflected.

16. The acceleration sensor of claim 15, wherein on both sides of the connecting beam there run bearer beams for accommodating the comb-shaped electrodes that are connected fixedly to the substrate, the bearer beams also being fastened to the substrate in the central area of the substrate.

17. The acceleration sensor of claim 11, wherein the areas in which the connecting beam and the bearer beams are fastened to the substrate are situated on a line that runs transverse to the direction of deflection of the seismic mass.

18. The acceleration sensor of claim 11, wherein the seismic mass is connected to the substrate by a pair of S-shaped flexible springs that are arranged mirror-symmetrically.

19. The acceleration sensor of claim 11, wherein there is at least one pair of comb-shaped electrodes whose overlap length increases when there is a deflection of the seismic mass in the wafer plane, and at least one additional pair of comb-shaped electrodes whose overlap length decreases upon the same deflection of the seismic mass in the wafer plane.

20. The acceleration sensor of claim 11, wherein at least parts of at least one of the seismic mass and of the transverse webs of the comb-shaped electrodes are perforated surfaces.
